(19) United States
(12) Patent Application Publication
(10) Pub. No.: US 2008/0057432 A1
(43) Pub. Date: Mar. 6, 2008

(54) Toner composition and method of preparation

(75) Inventors: Sang-deok Kim, Gwangmyeong-si (KR); Kyung-Yol Yon, Seongnam-si (KR); Duck-hee Lee, Seoul (KR); Seok-hoon Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/785,165

(22) Filed: Apr. 16, 2007

(30) Foreign Application Priority Data
Sep. 6, 2006 (KR) 10-2006-0085594

(51) Int. Cl. G03C 5/00

(52) U.S. Cl. 430/111.4; 430/105; 430/137.18; 430/137.21

(57) ABSTRACT

A toner composition preparation method is provided which can improve dispersibility of a colorant in a toner composition to form images of a high quality, enhance the fixing property and fluidity of the toner, and prevent a developing member from being contaminated due to inferior dispersibility of the colorant. According to the exemplary embodiment of the present invention, the toner composition preparation method by mixing a first binder resin with a colorant to prepare a master batch mixture; and adding a second binder resin, a releasing agent and a charge controlling agent to the obtained master batch mixture to produce the toner composition, wherein a melting point of the first binder resin is lower than that of the second binder resin.

### CROSS-REFERENCE TO RELATED APPLICATIONS

This application claims the benefit under 35 U.S.C. § 119 (a) of Korean Patent Application No. 10-2006-0085594, filed on Sep. 6, 2006, in the Korean Intellectual Property Office, the entire disclosure of which is hereby incorporated by reference.

### BACKGROUND OF THE INVENTION

1. Field of the Invention

The present invention relates to a toner composition preparation method. More particularly, the invention is directed to a toner composition preparation method which can improve dispersibility of a colorant in a toner composition to form images of a high quality, enhance the fixing property and fluidity of the toner, and prevent contamination of the developing member which can be caused by inadequate dispersibility of the colorant.

2. Description of the Related Art

Toner compositions are used for various purposes, particularly in image forming apparatuses for forming images. Toners are generally classified as dry toners and wet toners. Dry toners are prepared more easily than wet toners, and can be readily stored and used after preparation. Wet toners are used as a liquid toner to obtain clearer images, but preparation is more complex than for dry toners. Additionally, it is difficult to store wet toners, and they need to be used carefully.

Generally, dry toners are prepared by adding a colorant to a binder resin. In addition to the colorant and the binder resin, a releasing agent, a charge controlling agent, and other additives are also added to prepare a dry toner. Additives are classified as internal additives added to the interior of the toner particles, and external additives added onto the surface of the toner particles. Additives are added in order to improve various characteristics of toners or to overcome the drawbacks of toners.

In contrast to monochrome image forming apparatuses, color image forming apparatuses form images of various colors using four standard color toners, such as cyan (C), magenta (M), yellow (Y), and black (K).

For example, magenta and yellow toners are mixed to form red, and accordingly color image forming apparatuses have a thicker image toner layer than monochrome image forming apparatuses. In order to maintain the fixing property of the toner layer with a thickness greater than that of the toner layer in monochrome image forming apparatuses, a higher level fixing property is required in color image forming apparatuses than in monochrome image forming apparatuses.

Additionally, double-sided printing has been required in order to reduce the excessive use of printing paper which causes environmental problems. During double-sided printing, in which printing is performed on both sides of a sheet of printing paper, wrap jam can occur more frequently in a fixing device than during single-sided printing. Accordingly, a method is required to solve such problems.

In addition to these problems, recently color image forming apparatuses in which a large amount of colorants are used have been preferred and color image forming apparatuses are used more frequently, which generates problems. In the situation in which colorants are used, there are limits to the amount of colorants that may be used due to the greater difficulty of dispersing colorants in the binder resin than in toners where colorants are not used.

If the colorant is dispersed in a binder resin which determines the fixing property, the viscosity of the colorant varies greatly according to the melting temperature of the binder resin, and accordingly it is difficult to disperse the colorant in the binder. Therefore, if the colorant is dispersed when a toner is prepared using various types of binder resin, the melting temperature of the binder resin and the different levels of viscosity of the colorant according to temperature should be considered.

Therefore, a method is required to improve the dispersibility of a colorant in a binder resin when preparing a toner composition and to not uniformly disperse the colorant in the binder.

### SUMMARY OF THE INVENTION

Exemplary embodiments of the present invention address at least the above problems and/or disadvantages and provide at least the advantages described below. Accordingly, an exemplary aspect of the present invention is to provide a toner composition preparation method which can improve dispersibility of a colorant in a toner composition to form images of a high quality, enhance the fixing property and fluidity of the toner, and prevent contamination of a developing member caused by inferior dispersibility of the colorant.

In order to achieve the above-described aspects of the present invention, a toner composition preparation method is provided, which comprises mixing a first binder resin with a colorant to prepare a master batch mixture; and adding a second binder resin, a releasing agent and a charge controlling agent to the master batch mixture to form the toner composition. In one embodiment, the melting point of the first binder resin is lower than that of the second binder resin.

In the master batch mixture comprising the first binder resin and the colorant, the amount of the colorant may be about 20% by weight to about 40% by weight based on the total weight of the master batch mixture.

The first binder resin may have a melting point of about 125° C. or lower and a weight average molecular weight of approximately 20,000. In one embodiment, the first binder is a polyester resin.

Additionally, the first binder resin may have a glass transition temperature of about 58° C. to 60° C.

The second binder resin may have a melting point of about 155° C. or higher, and have a weight average molecular weight of approximately 100,400. In one embodiment, the second binder resin is a polyester resin.

Additionally, the second binder resin may have a glass transition temperature of about 60° C. to 63° C.

According to one exemplary aspect of the present invention, a toner composition comprises about 20% by weight of the first binder resin, about 4% by weight of the colorant, about 72% by weight of the second binder resin, about 2% by weight of the releasing agent, and about 2% by weight of the charge controlling agent, based on the total weight of the toner composition.

These and other aspects of the invention will become apparent from the following detailed description of the invention which disclose various embodiments of the invention.

### DETAILED DESCRIPTION OF EXEMPLARY EMBODIMENTS

Certain exemplary embodiments of the present invention will now be described in greater detail.

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

According to an exemplary embodiment of the present invention, a toner composition preparation method is provided, which comprises mixing a first binder resin with a colorant to prepare a master batch; and adding a second binder resin, a releasing agent and a charge controlling agent to the master batch mixture to obtain a toner composition.

Examples of the binder resin that can be used in the toner composition include styrene such as polystyrene and polyvinyltoluene, a homopolymer of a styrene derivative, a styrene copolymer such as a styrene-acrylic copolymer, polyethylene, polypropylene, a vinyl chloride-based resin, polyacrylate, polymethacrylate, polyester, polyacrylonitrile, a melamine resin, and an epoxy resin, but are not necessarily limited thereto. Additionally, two or more types of the above resins may be used in combination.

In the exemplary embodiment of the present invention, two types of binder resin are used, where the melting point of the first binder resin is lower than that of the second binder resin. In other words, one type of the binder resin has a melting point which is lower than that of the other type thereof.

The type of binder resin having a lower melting point than the other type thereof is pre-mixed with a colorant having a poor dispersibility, to obtain a master batch. The term “master batch” refers to a mixture in which a colorant for coloring raw materials of plastic and other additives are concentrated with the plastic at a high concentration, and then the concentrate is dispersed substantially uniformly.

If a binder resin having a high melting point is used to prepare the master batch, excellent dispersibility of the colorant is exhibited due to a decrease in the viscosity compared to a binder resin having a low melting point. Additionally, if a master batch process uses a high melting point binder, stress caused by the master batch process may reduce the properties of the binder resin. Therefore, the binder resin having a low melting point is used in the master batch process to produce the master batch, and the binder resin having a high melting point is used without the master batch process.

In this embodiment, the binder resin having a low melting point is referred to as a first binder resin, and the binder resin having a high melting point is referred to as a second binder resin.

In the exemplary embodiment of the present invention, the first binder resin may comprise a polyester resin. In addition, the first binder resin may have a melting point of about 125° C. or lower, and have a weight average molecular weight of approximately 20,000. Additionally, the glass transition temperature of the first binder resin may be about 58° C. to 60° C.

The second binder resin may have a melting point of about 155° C. or higher, which is higher than that of the first binder resin. In one embodiment, the first and second binder resins have melting points that differ by at least about 25° C.

Furthermore, the second binder resin may comprise a polyester resin in the same manner as the first binder resin. In one suitable embodiment, the polyester resin has a weight average molecular weight of approximately 100,400. In other embodiments, the first and second binder resins can be the same or different.

Additionally, the second binder resin may have a glass transition temperature of about 60° C. to 63° C.

The colorant embodies colors of toner particles, and is classified as either a pigment-based colorant or a dye-based colorant. Any generally usable colorant can be used as a colorant of the exemplary embodiment of the present invention, and it is desirable to use a pigment-based colorant which has excellent heat stability and light resistance.

Examples of the pigment-based colorant usable in the toner composition include colored organic pigments such as azo-based pigments, phthalocyanine-based pigments, basic dye-based pigments, quinacridone-based pigments, dioxazine-based pigments, and condensed azo-based pigments; colored inorganic pigments such as chromates, ferrocyanides, oxides, sulfides, selenides, sulfates, silicates, carbonates, phosphates, and metal powder; and black inorganic pigments such as carbon black. These pigments can be used alone or in combination of two or more, but the pigment-based colorant usable in the toner composition of the exemplary embodiment of the present invention is not limited thereto.

Problems may arise so that it is difficult to knead a colorant, particularly a pigment-based colorant, with a binder resin. Therefore, in the preparation method according to the exemplary embodiment of the present invention, a colorant is used which has been subjected to a master batch process together with a binder resin prior to mixing or kneading with the second binder resin and other toner components.

In the master batch mixture comprising the first binder resin and the colorant, the amount of the colorant may be about 20% by weight to about 40% by weight based on the total weight of the master batch mixture.

When a toner image is transferred and fused onto a recording medium, the releasing agent, as an additive, enhances a mold releasing effect between the roller and the toner and prevents toner offset. Additionally, the releasing agent prevents the occurrence of recording medium jam resulting from the recording medium being adhered to the roller. The releasing agent is generally added to toner particles as an internal additive in the toner composition.

The releasing agent typically includes low-molecular weight polyolefins, silicones that soften upon heating, fatty acid amides, wax, or the like. Generally, commercially available wax can be readily used as a releasing agent.

Examples of the wax that may be used as a releasing agent in the toner composition include natural waxes including vegetable waxes such as carnauba wax or bayberry wax, and animal waxes such as bees wax, Shellac wax, or Spermacetti wax; mineral waxes such as Montan wax, Ozokerite wax, and Ceresine wax; and synthetic waxes such as paraffin wax, microcrystalline wax, polyethylene wax, polypropylene wax, acrylate wax, fatty acid amide wax, silicone wax and polytetrafluoroethylene wax; or the like. These waxes can be used alone or in combination of two or more. The wax usable in the exemplary embodiments of the present invention is not limited thereto.

The wax usable in the toner composition according to the exemplary embodiment of the present invention may have a low melting point, and accordingly a mold releasing effect can be effectively exerted. If the melting point of the wax increases, the dispersibility of toner particles is reduced, but, on the other hand, if the melting point of the wax decreases, the dispersibility of toner particles is improved. Therefore, suitable waxes can be selected and used by taking into consideration such conditions.

The charge controlling agent is added in order to control the quantity of electric charge, charged to toner particles, and is referred to as a charge regulator or an electrification regulating agent. Additionally, the types of charge controlling agent to be added differ according to the electric charge of the toner particles (positive charge (+) or negative charge

For a negative charge controlling agent, an azo-based dye, a salicylic acid compound containing a metal such as chromium, iron or zinc, or the like may be used. A positive charge controlling agent may be, for example a nigrosine dye, a quaternary ammonium salt, a triphenylmethane derivative, or the like.

Commercially available charge controlling agents which may be used in the toner composition of the exemplary embodiment of the present invention include nigrosine NO1 (manufactured by Orient Chemical Co.), nigrosine EX (manufactured by Orient Chemical Co.), Aizen Spilon black TRH (manufactured by Hodogaya Chemical Co.), T-77 (manufactured by Hodogaya Chemical Co.), Bontron S-34 (manufactured by Orient Chemical Co.), and Bontron E-84 (manufactured by Orient Chemical co.).

According to the exemplary embodiment of the present invention, the toner composition comprises about 20% by weight of the first binder resin, about 4% by weight of the colorant, about 72% by weight of the second binder resin, about 2% by weight of the releasing agent, and about 2% by weight of the charge controlling agent, based on the total weight of the toner composition.

In the exemplary embodiment of the present invention, only the first binder resin and the colorant are pre-mixed to prepare the master batch, and subsequently the obtained master batch mixture is introduced into a kneader for kneading. The residual materials are introduced without pre-mixing to prepare a toner composition. In particular, a toner grinding method is used to prepare a toner in exemplary embodiments of the present invention.

The toner composition prepared according to the exemplary embodiment of the present invention can be utilized in image forming apparatuses such as laser beams or light emitting diode (LED) print head type printers, facsimiles, copying machines, or multi-function peripheral (MFP) devices.

Hereinafter, a toner composition will be prepared according to the exemplary embodiment of the present invention.

### EXAMPLE

A toner composition was prepared using a toner composition preparation method according to the exemplary embodiment of the present invention. A first binder resin and a colorant were first added to prepare the master batch mixture. To the obtained master batch mixture were added a second binder resin, a releasing agent, and a charge controlling agent, and then the resulting mixture was pulverized using a grinder. The pulverized mixture was introduced into an extrusion kneader to perform kneading and then extruded, pulverized and classified to form the toner composition.

Hereinafter, a toner composition of Example 1 was prepared by mixing a colorant with a first binder resin to obtain a master batch mixture. A toner composition of Comparative Example 1 was prepared without forming a mater batch mixture, and a toner composition of Comparative Example 2 was prepared by mixing a colorant with a second binder resin instead of a first binder resin to obtain a master batch mixture.

Materials used in each of Example and Comparative Examples are described below.

(1) First Binder Resin
Polyester-based resin (manufactured by Mitsubishi Rayon Co., Ltd.)
Glass transition temperature=58° C. to 60° C.
Melting point=125° C.
Average molecular weight=20,000
Weight ratio=20% by weight (based on the total weight of the toner composition)

(2) Second Binder Resin
Polyester-based resin (manufactured by Mitsubishi Rayon Co., Ltd.)
Glass transition temperature=60° C. to 63° C.
Melting point=155° C.
Average molecular weight=100,400
Weight ratio=72% by weight (based on the total weight of the toner composition)

(3) Colorant
Cyan=PB 15:3
Magenta=PR 57:1
Yellow=PY 180
Black=Mogul L (manufactured by Cabot Corporation)
Weight ratio=4% by weight (based on the total weight of the toner composition)

(4) Releasing Agent
Low-melting point polyethylene wax
Weight ratio=2% by weight (based on the total weight of the toner composition)

(5) Charge Controlling Agent
Cyan, Magenta, Yellow: Bontron E-84 (manufactured by Orient Chemical co.)
Black: T-77 (manufactured by Hodogaya Chemical Co.),
Weight ratio=2% by weight (based on the total weight of the toner composition)

The kneading condition of the extrusion kneader is described as follows.
Extrusion kneader: PCM 30 (co-rotating twin extruder, manufactured by Ikegai Corporation, L/D=31.5)
Extrusion resin temperature: 125° C. to 130° C.

### Example 1

As described above, a first binder resin and a colorant were mixed to prepare a master batch mixture. A second binder resin, a releasing agent, and a charge controlling agent were added to the master batch mixture, and then the resulting mixture was kneaded and pulverized using a mechanical grinder (SR-15). A classification process was performed to prepare a toner composition.

The kneading ratio of the first binder resin to the colorant in the master batch mixture was 65:35.

### Comparative Example 1

A first binder resin, a colorant, a second binder resin, a releasing agent, and a charge controlling agent were pre-mixed, and the mixture was introduced into a kneader. Kneading, pulverizing processes and the like were performed to prepare a toner composition. The toner composition was prepared in the same manner as in Example 1 except that all the materials were pre-mixed.

### Comparative Example 2

A colorant was mixed with a second binder resin instead of a first binder resin to prepare a master batch mixture. A first binder resin, a releasing agent, and charge controlling agent were added thereto, and a toner composition was prepared through kneading, pulverizing processes and the like. In other words, the toner composition was prepared in the same manner as in Example 1, except that the second binder resin was used instead of the first binder resin during the formation of the master batch mixture, and the first binder resin was inserted then added the master batch process.

The kneading ratio of the second binder resin to the colorant in the master batch mixture was 65:35.

### Toner Preparation

The mixtures obtained in Example and Comparative Examples were classified by a classifier to obtain toner particles (D50=8 μm).

### Evaluation

The dispersibility of the colorant was evaluated using the toner composition prepared in the Examples. Developed images and the fixing property of the toner compositions were evaluated to estimate the dispersibility of the colorant.

(1) Image Evaluation

The image was evaluated based on the background and the contamination level of the developing member (particularly, the occurrence or nonoccurrence of streaks due to adhesion of the toner to a doctor blade, which is caused by a decrease in the durability of the toner), based on the evaluation of the running of the H/H environment. The results of each evaluation given in Example 1 and Comparative Examples 1 and 2 are shown in Table 1.

In the sensory evaluation, the background refers to the toner contamination level in an area in which an image is not formed as judged by an evaluator. The results were recorded using ◯ to represent “Excellent”, Δ to represent “Good”, and x to represent “Poor” in Table 1.

TABLE 1

| | | | Occurrence or |
|---|---|---|---|
| | | | nonoccurrence of |
| | | | streaks caused by |
| | Background | | doctor blade and |
| | | After running 2000 | Occurrence area of |
| | Initial stage | cycles | streak |
| Example 1 | ◯ | ◯ | Not occurring |
| Comparative | ◯ | X | Occurring around |
| Example 1 | | | 1500 cycles |
| Comparative | ◯ | Δ | Occurring around |
| Example 2 | | | 800 cycles |

As shown in Table 1, it was found that in the toner prepared according to the exemplary embodiment of the present invention, the background was not observed even after running 2000 cycles, and streaks did not occur.

However, when a toner composition is prepared without pre-mixing a master batch of the first binder resin and the colorant, or is prepared by mixing the colorant with a second binder resin having a higher melting point than the first binder resin to obtain a master batch mixture, the background was observed after running 2000 cycles, and streaks caused by the doctor blade occurred. Therefore, it was found that an image poorer quality was shown compared to the toner composition in Example 1.

(2) Fixing Property Evaluation

Using a fixing jig, the fixing property was evaluated according to the temperature, the processing speed, and the weight of sheets of paper supplied.

Evaluation was performed with respect to each temperature on a surface of a fixing device, for processing speeds of 125 mm/s and 150 mm/s, and for sheets of printing paper of 60 g, 75 g and 100 g using the fixing jig. Additionally, the fixing property was measured for each color, and then the measurement was performed with respect to superimposed color images.

As the fixing device, Soft double-sided rolls of CLP-500 color laser printer were used. The results of the evaluation are shown in Tables 2 to 13. The symbols in Tables 2 to 13 are defined as follows:

◯: Excellent, the image quality is excellent, with no occurrence of cold-offset, paper wrap jam, and hot offset.

Δ: Good, problems are not visible to the naked eye, but occurrence of slight peeling when lightly rubbed with a finger in the case of the cold-offset.

x: Poor, with occurrence of cold-offset, paper wrap jam, and hot offset.

<Fixing Property Evaluation of Toner Composition in Example 1>

TABLE 2

| Single image processing speed of | | | Temperature (° C.) | | | |
|---|---|---|---|---|---|---|
| 125 mm/s | | | 160 | 170 | 180 | 190 |
| Sheets of | Y | 60 | ◯ | ◯ | ◯ | ◯ |
| paper (g) | | 75 | ◯ | ◯ | ◯ | ◯ |
| | | 100 | ◯ | ◯ | ◯ | ◯ |
| | M | 60 | ◯ | ◯ | ◯ | ◯ |
| | | 75 | ◯ | ◯ | ◯ | ◯ |
| | | 100 | Δ | ◯ | ◯ | ◯ |
| | C | 60 | ◯ | ◯ | ◯ | ◯ |
| | | 75 | ◯ | ◯ | ◯ | ◯ |
| | | 100 | Δ | ◯ | ◯ | ◯ |
| | K | 60 | ◯ | ◯ | ◯ | ◯ |
| | | 75 | ◯ | ◯ | ◯ | ◯ |
| | | 100 | ◯ | ◯ | ◯ | ◯ |

TABLE 3

| Single image processing speed of | | | Temperature (° C.) | | | |
|---|---|---|---|---|---|---|
| 150 mm/s | | | 160 | 170 | 180 | 190 |
| Sheets of | Y | 60 | ◯ | ◯ | ◯ | ◯ |
| paper (g) | | 75 | ◯ | ◯ | ◯ | ◯ |
| | | 100 | Δ | ◯ | ◯ | ◯ |
| | M | 60 | ◯ | ◯ | ◯ | ◯ |
| | | 75 | Δ | ◯ | ◯ | ◯ |
| | | 100 | X | ◯ | ◯ | ◯ |
| | C | 60 | ◯ | ◯ | ◯ | ◯ |
| | | 75 | ◯ | ◯ | ◯ | ◯ |
| | | 100 | X | Δ | ◯ | ◯ |
| | K | 60 | ◯ | ◯ | ◯ | ◯ |
| | | 75 | Δ | ◯ | ◯ | ◯ |
| | | 100 | X | ◯ | ◯ | ◯ |

TABLE 4

| | |
|---|---|
| Superimposed image | |
| processing speed of | Temperature (° C.) |

| | | | | |
|---|---|---|---|---|
| 125 mm/s | 160 | 170 | 180 | 190 |

| | | | | | |
|---|---|---|---|---|---|
| Sheets of | 60 | ◯ | ◯ | ◯ | ◯ |
| paper (g) | 75 | ◯ | ◯ | ◯ | ◯ |
| | 100 | X | ◯ | ◯ | ◯ |

TABLE 5

| Superimposed image | | Temperature (° C.) | | | |
|---|---|---|---|---|---|
| processing speed of 150 mm/s | | 160 | 170 | 180 | 190 |
| Sheets of | 60 | ◯ | ◯ | ◯ | ◯ |
| paper (g) | 75 | Δ | ◯ | ◯ | ◯ |
| | 100 | X | Δ | ◯ | ◯ |

<Fixing Property Evaluation of Toner Composition in Comparative Example 1>

TABLE 6

| Single image processing speed of | | | Temperature (° C.) | | | |
|---|---|---|---|---|---|---|
| 125 mm/s | | | 160 | 170 | 180 | 190 |
| Sheets of | Y | 60 | ◯ | ◯ | X | X |
| paper (g) | | 75 | ◯ | ◯ | ◯ | X |
| | | 100 | Δ | ◯ | ◯ | ◯ |
| | M | 60 | ◯ | ◯ | X | X |
| | | 75 | ◯ | ◯ | ◯ | ◯ |
| | | 100 | Δ | ◯ | ◯ | ◯ |
| | C | 60 | ◯ | ◯ | X | X |
| | | 75 | Δ | ◯ | ◯ | X |
| | | 100 | Δ | ◯ | ◯ | ◯ |
| | K | 60 | ◯ | ◯ | ◯ | X |
| | | 75 | Δ | ◯ | ◯ | ◯ |
| | | 100 | X | Δ | ◯ | ◯ |

TABLE 7

| Single image processing speed of | | | Temperature (° C.) | | | |
|---|---|---|---|---|---|---|
| 150 mm/s | | | 160 | 170 | 180 | 190 |
| Sheets of | Y | 60 | ◯ | ◯ | ◯ | X |
| paper (g) | | 75 | ◯ | ◯ | ◯ | ◯ |
| | | 100 | Δ | ◯ | ◯ | ◯ |
| | M | 60 | ◯ | ◯ | ◯ | X |
| | | 75 | X | ◯ | ◯ | ◯ |
| | | 100 | X | Δ | ◯ | ◯ |
| | C | 60 | ◯ | ◯ | ◯ | X |
| | | 75 | X | ◯ | ◯ | ◯ |
| | | 100 | X | Δ | ◯ | ◯ |
| | K | 60 | ◯ | ◯ | ◯ | ◯ |
| | | 75 | Δ | ◯ | ◯ | ◯ |
| | | 100 | X | X | ◯ | ◯ |

TABLE 8

| Superimposed image | | Temperature (° C.) | | | |
|---|---|---|---|---|---|
| processing speed of 125 mm/s | | 160 | 170 | 180 | 190 |
| Sheets of | 60 | ◯ | ◯ | ◯ | ◯ |
| paper (g) | 75 | Δ | ◯ | ◯ | ◯ |
| | 100 | X | X | ◯ | ◯ |

TABLE 9

| Superimposed image | | Temperature (° C.) | | | |
|---|---|---|---|---|---|
| processing speed of 150 mm/s | | 160 | 170 | 180 | 190 |
| Sheets of | 60 | Δ | ◯ | ◯ | ◯ |
| paper (g) | 75 | X | X | ◯ | ◯ |
| | 100 | X | X | Δ | ◯ |

<Fixing Property Evaluation of Toner Composition in Comparative Example 2>

TABLE 10

| Single image processing speed of | | | Temperature (° C.) | | | |
|---|---|---|---|---|---|---|
| 125 mm/s | | | 160 | 170 | 180 | 190 |
| Sheets of | Y | 60 | ◯ | ◯ | ◯ | X |
| paper (g) | | 75 | ◯ | ◯ | ◯ | ◯ |
| | | 100 | X | ◯ | ◯ | ◯ |
| | M | 60 | ◯ | ◯ | ◯ | X |
| | | 75 | ◯ | ◯ | ◯ | ◯ |
| | | 100 | X | ◯ | ◯ | ◯ |
| | C | 60 | ◯ | ◯ | ◯ | X |
| | | 75 | ◯ | ◯ | ◯ | ◯ |
| | | 100 | Δ | ◯ | ◯ | ◯ |
| | K | 60 | ◯ | ◯ | ◯ | ◯ |
| | | 75 | ◯ | ◯ | ◯ | ◯ |
| | | 100 | X | ◯ | ◯ | ◯ |

TABLE 11

| Single image processing speed of | | | Temperature (° C.) | | | |
|---|---|---|---|---|---|---|
| 150 mm/s | | | 160 | 170 | 180 | 190 |
| Sheets of | Y | 60 | ◯ | ◯ | ◯ | ◯ |
| paper (g) | | 75 | Δ | ◯ | ◯ | ◯ |
| | | 100 | X | X | ◯ | ◯ |
| | M | 60 | ◯ | ◯ | ◯ | ◯ |
| | | 75 | Δ | ◯ | ◯ | ◯ |
| | | 100 | X | X | ◯ | ◯ |
| | C | 60 | ◯ | ◯ | ◯ | ◯ |
| | | 75 | X | ◯ | ◯ | ◯ |
| | | 100 | X | Δ | ◯ | ◯ |
| | K | 60 | ◯ | ◯ | ◯ | ◯ |
| | | 75 | Δ | ◯ | ◯ | ◯ |
| | | 100 | X | X | ◯ | ◯ |

TABLE 12

| Superimposed image | | Temperature (° C.) | | | |
|---|---|---|---|---|---|
| processing speed of 125 mm/s | | 160 | 170 | 180 | 190 |
| Sheets of | 60 | ◯ | ◯ | ◯ | X |
| paper (g) | 75 | Δ | ◯ | ◯ | X |
| | 100 | X | Δ | ◯ | ◯ |

TABLE 13

| Superimposed image | | Temperature (° C.) | | | |
|---|---|---|---|---|---|
| processing speed of 150 mm/s | | 160 | 170 | 180 | 190 |
| Sheets of | 60 | Δ | ◯ | ◯ | ◯ |
| paper (g) | 75 | X | Δ | ◯ | ◯ |
| | 100 | X | X | Δ | ◯ |

Tables 2 to 5 show the results of the fixing property evaluation of the toner composition prepared in Example 1. In Tables 2 and 3 showing the results of evaluating the fixing property according to each color, the fixing property was excellent except that “A” was shown only twice at the surface temperature of 160° C. when the processing speed was set at 125 mm/s.

If the processing speed was set at 150 mm/s, the poor fixing property of the toner composition prepared in Example 1 was shown three times. However, in the same condition, the toner compositions prepared in Comparative Examples 1 and 2 exhibited a poor fixing property eight to nine times (referring to Tables 7 and 11). Therefore, the toner composition prepared in Example 1 was found to be of higher quality than those in Comparative Examples 1 and 2.

Additionally, even when the images were superimposed, the toner composition prepared in Example 1 had an excellent fixing property except that a poor fixing property was shown once at a the processing speed of 125 mm/s, and a good fixing property was recorded twice and a poor fixing property was recorded once at a processing speed of 150 mm/s.

On the other hand, when the processing speed of superimposed images was set at 125 mm/s, the toner compositions prepared in Comparative Examples 1 and 2 exhibited a poor fixing property two to three times (referring to Tables 8 and 12). Therefore, the toner composition prepared in Example 1 was found to be of higher quality than those in Comparative Examples 1 and 2.

If the processing speed of superimposed images is 150 mm/s, there is quite a clear difference in the results between the toner composition prepared in Example 1 and the toner compositions prepared in Comparative Examples 1 and 2. In each of the toner compositions prepared in Comparative Examples 1 and 2, the frequency of poor and good fixing property reached 50% of the total number of sheets evaluated, and thus there is a distinction in the fixing property from the toner composition prepared according to the preparation method of the exemplary embodiment of the present invention.

Referring to the results of the above-described evaluations, the toner composition prepared according to the preparation method of the exemplary embodiment of the present invention is generally excellent in image and fixing property. Additionally, it was found that problems caused by an inferior dispersibility of the colorant were solved.

As described above, according to the exemplary embodiment of the present invention, the dispersibility of the colorant in the toner composition increases, and therefore, it is possible to form images of a high quality, enhance the fixing property and fluidity of the toner, and prevent the image and developing member from being contaminated due to the poor dispersibility of the colorant.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A toner composition preparation method comprising:
mixing a first binder resin with a colorant to prepare a master batch mixture; and
adding a second binder resin, a releasing agent and a charge controlling agent to the master batch mixture and forming the toner composition,
wherein the melting point of the first binder resin is lower than that of the second binder resin.

2. The method as claimed in claim 1, wherein in the master batch mixture comprising the first binder resin and the colorant, the amount of the colorant is about 20% by weight to about 40% by weight based on the total weight of the master batch mixture.

3. The method as claimed in claim 1, wherein the first binder resin has a melting point of about 125° C. or lower.

4. The method as claimed in claim 1, wherein the first binder resin comprises a polyester resin, and has a weight average molecular weight of approximately 20,000.

5. The method as claimed in claim 1, wherein the first binder resin has a glass transition temperature of about 58° C. to about 60° C.

6. The method as claimed in claim 1, wherein the second binder resin has a melting point of about 155° C. or higher.

7. The method as claimed in claim 1, wherein the second binder resin comprises a polyester resin, and has a weight average molecular weight of approximately 100,400.

8. The method as claimed in claim 1, wherein the second binder resin has a glass transition temperature of about 60° C. to about 63° C.

9. The method as claimed in claim 1, wherein the toner composition comprises about 20% by weight of the first binder resin, about 4% by weight of the colorant, about 72% by weight of the second binder resin, about 2% by weight of the releasing agent, and about 2% by weight of the charge controlling agent, based on the total weight of the toner composition.

10. The method of claim 1, wherein the colorant is combined with the first binder resin to form a substantially uniform mixture.

11. The method of claim 10, further comprising kneading and pulverizing the toner mixture to obtain the toner composition.

12. The method of claim 1, wherein the melting point of the first binder resin and the melting point of the second binder resin differ by at least about 25° C.

13. The method of claim 1, wherein the first and second binder resins are of the same type or of different types.

14. A toner composition prepared by the steps of:
mixing a first binder resin with a colorant to obtain a master batch mixture;
adding a second binder resin, a releasing agent and a charge control agent to the master batch mixture, wherein the melting point of the first binder resin is lower than that of the second binder resin; and
kneading and pulverizing the resulting mixture to form the toner composition.

15. The toner composition of claim 14, wherein the master batch mixture comprises the colorant in an amount of about 20% by weight to about 40% by weight based on the total weight of the first binder resin and the colorant.

16. The toner composition of claim 14, wherein the first binder resin has a melting point of about 125° C. or lower.

17. The toner composition of claim 14, wherein the first binder resin has a glass transition temperature of about 58° C. to about 60° C.

18. The toner composition of claim 14, wherein the second binder resin has a melting point of about 155° C. or higher.

19. The toner composition of claim 14, wherein the second binder resin has a glass transition temperature of about 60° C. to about 63° C.

20. The toner composition of claim 14, wherein the toner composition comprises about 20% by weight of the first binder resin, about 4% by weight of the colorant, about 72% by weight of the second binder resin, about 2% by weight of the releasing agent, and about 2% by weight of the charge controlling agent, based on the total weight of the toner composition.
